(19) United States
(12) Patent Application Publication
(10) Pub. No.: US 2006/0155077 A1
(43) Pub. Date: Jul. 13, 2006

(54) Tyre for vehicle wheels and elastomeric composition

(76) Inventors: Maurizio Galimberti, Milano (IT); Giuseppina Ratti, Milano (IT); Antonio Cascion Ingurgio, Milano (IT); Attilio Citterio, Milano (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/534,545

(22) PCT Filed: Dec. 12, 2002
(86) PCT No.: PCT/EP02/14145

§ 371 Date: Oct. 27, 2005

(51) Int. Cl. C08C 19/00

(52) U.S. Cl. 525/332.5

(57) ABSTRACT

A crosslinkable elastomeric composition includes at least one diene elastomeric polymer and at least one organic quaternary ammonium salt. The at least one diene elastomeric polymer may have a glass transition temperature (T_{g}) below 20° C. The at least one organic quaternary ammonium salt may be present in an amount from 0.1 phr to 10 phr. The elastomeric composition may include at least one primary accelerator selected from thiazoles, sulphenamides, and/or xanthogenates. The elastomeric composition may be substantially free of additional secondary accelerators. The elastomeric composition may include at least one reinforcing filler, such as carbon black and/or silica. A tyre for a vehicle wheel includes at least one structural element including the elastomeric composition. The tyre may include a carcass structure, a belt structure, a tread band, and a pair of sidewalls. The at least one structural element including the elastomeric composition may be the tread band.

The present invention relates to a tyre for vehicle wheels, to a tread band and to a crosslinkable elastomeric composition.

More particularly, the present invention relates to a tyre for vehicle wheels comprising at least one structural element including an elastomeric composition comprising at least one organic quaternary ammonium salt.

The present invention moreover relates to a tread band including a crosslinkable elastomeric composition comprising at least one organic quaternary ammonium salt, and also to an elastomeric composition comprising at least one organic quaternary ammonium salt.

In the rubber industry, in particular in the manufacture of tyres for vehicle wheels, the use is known of elastomeric compositions wherein reinforcing fillers have been incorporated in the elastomeric polymers commonly used, in order to improve the characteristics of the final crosslinked manufactured product, in particular mechanical properties and abrasion resistance. Thanks to its high reinforcing efficiency, carbon black is the most widely employed reinforcing filler. However, carbon black imparts to the crosslinked product marked hysteretic characteristics, i.e. an increase of heat dissipated in dynamic conditions which, as is known, causes, in particular in the case of a tyre, an increase in the rolling resistance of the tyre itself. This leads to an increase of the fuel consumption of the vehicles and hence of both locomotion costs and air pollution. It is possible to try to reduce the adverse effects by employing smaller amounts of carbon black and/or a carbon black having a smaller surface area. This inevitably leads to a reduction of the reinforcing action, with a worsening of the mechanical properties and of the abrasion resistance of the final crosslinked manufactured product.

In order to reduce the hysteretic characteristics of the final crosslinked manufactured product it is known to use the so-called “white” reinforcing fillers such as, for example, gypsum, talc, kaolin, bentonite, titanium oxide, silicates of various types and in particular silica, which may replace carbon black either entirely or partly. In this regard, see for example, European Patent EP 501,227.

The use of silica-based reinforcing fillers involves several drawbacks, substantially related to the poor affinity of the same with respects to the elastomeric polymers commonly used in the tyre manufacture. In particular, to obtain a good dispersion degree of silica within the elastomeric polymers it is necessary to submit the elastomeric compositions to an extensive thermal-mechanical mixing action. To increase the affinity between silica and the elastomeric polymers, it is necessary to employ suitable coupling agents such as, for example, sulfur-containing organosilane products. However, the need of using such coupling agents sets a limit to the maximum temperature that may be reached during mixing and thermal-mechanical processing operations, in order to avoid an irreversible thermal degradation of the coupling agent.

Moreover, the use of silica-based reinforcing fillers in relatively large amounts causes an undesirable slowdown of the vulcanization rate of the elastomeric compositions. Usually, in order to increase said vulcanization rate, it is known to add to the elastomeric compositions, besides the primary accelerators such as, for example, thiourea, sulfenamides, thiazoles, xanthogenates, secondary accelerators such as, for example, dithiocarbamates, thiouree, thiurams, Schiff's bases or other amino accelerators, guanidines, in particular diphenylguanidine (DPG). However, the presence of said secondary accelerators may, in some cases, entail considerable problems in terms of harmfulness/toxicity both during production and during use. Moreover, diphenyl guanidine may cause, during the vulcanization step which is generally carried out at temperatures above 110° C., formation of aniline or aniline derivatives which are noxious by-products.

Moreover, the use of a primary accelerator combined with a secondary accelerator may cause a premature crosslinking of the elastomeric composition at the temperatures commonly used during processing, so that the elastomeric composition may partially crosslink before the molding and vulcanization step (“scorching”).

Attempts have been made in the prior art directed to increase the vulcanization rate of elastomeric compositions without causing scorching phenomena.

For example, U.S. Pat. No. 4,861,842 discloses a vulcanizable rubber composition comprising a rubber and a vulcanization system comprising: from about 0.50 phr to about 2.0 phr of a sulfenamide accelerator, from about 0.10 phr to about 1.0 phr of a guanidine accelerator, from about 0.10 phr to about 1. 0 phr of a thiuram accelerator, from about 0. 05 phr to about 1.0 phr of mercapto benzothiazyl disulfide, from about 0.75 phr to about 3.0 phr of a sulfur vulcanizing agent, from about 0.05 phr to about 0.50 phr of N-cyclohexylthio-phthalimide, from about 1. 0 phr to about 5.0 phr of a zinc compound, and from about 0.05 phr to about 1.0 phr of an activator having the following formula: 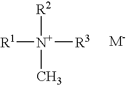
wherein R¹, R² and R³ are independently alkyl radicals having from 8 to 10 carbon atoms and M is selected from the group consiting of Cl, Br, CH₃SO₄ and HSO₄. Said vulcanizable rubber composition would show a very fast vulcanization rate without prematurely crosslinking during injection molding.

U.S. Pat. No. 5,187,239 discloses a method for increasing the vulcanization rate of a rubber composition comprising adding to a sulfur vulcanizable rubber a methyl trialkyl ammonium salt having the following formula: 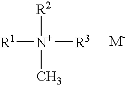
wherein R¹, R² and R³ are independently alkyl radicals having from 8 to 10 carbon atoms and M is selected from the group consiting of Cl, Br, CH₃SO₄ and HSO₄. In one embodiment, a single accelerator system may be used, i.e. primary accelerators such as, for example, a sulfenamide. In another embodiment, combination of two or more accelerators may be used which may consist of a primary accelerator and a secondary accelerator such as, for example, a guanidine, a dithiocarbamate or a thiuram compound. The addition of a methyl trialkyl ammonium salt of the formula disclosed above would significantly increase the vulcanization rate of the rubber.

U.S. Pat. No. 6,025,428 discloses sulfur-vulcanizable rubber compositions having a silica filler incorporated with optimization of the silica associated properties relating to wear, wet traction and rolling resistance. The silica associated properties are promoted by dispersing and coupling agents and, more particularly, the silica dispersion is improved through the use of a dispersing agent or aid comprising a quaternary ammonium compound and the timely addition thereof during the rubber mixing or blending process so as to not unnecessarily inhibit the coupling agent enhancement. The dispersing agents are quaternary ammonium compounds having the following formula: 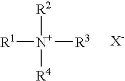
wherein R¹, R², R³ and R⁴, which may be the same or different, are alkyl, aryl and polyoxyethylene; and X is halogen. The delay in cure/vulcanization of rubber observed with the use of silica would been reduced by using the dispersing agents above disclosed. A further advantage is that a secondary accelerator such as diphenyl guanidine (DPG) should not be necessary anymore.

In the Applicant's view, crosslinkable elastomeric compositions wherein the amount of secondary accelerators is reduced, or even eliminated, should satisfy a number of requirements in order to make them advantageously useful in the production of crosslinked manufactured products, and in particular of tyres. As a matter of fact, the reduction or elimination of secondary accelerators should not compromise the fundamental properties of the crosslinked manufactured products, such as mechanical properties (both static and dynamic), as well as abrasion resistance. Moreover, said reduction or elimination should not decrease the vulcanization rate, so as to maintain it at an acceptable level from the point of view of industrial production.

The Applicant has now found that it is possible to obtain crosslinkable elastomeric compositions capable of being used advantageously in the production of crosslinked manufactured products, in particular in the production of tyre, using at least one organic quaternary ammonium salt having at least one group containing a non-ionic nitrogen atom as a secondary accelerator. The addition of said organic quaternary ammonium salt provides, even in the substantial absence of additional secondary accelerators, a crosslinked manufactured product that has good mechanical properties (both static and dynamic), while maintaining acceptable vulcanization rate. Applicant has also found that by using at least one organic quaternary ammonium salt as defined above having as anion group a carboxylate anion, it is possible to avoid also the use of stearic acid which, as known in the art, is usually used as a vulcanization activator.

According to a first aspect, the present invention thus relates to a tyre for vehicle wheels, comprising at least one structural element including an elastomeric composition comprising:
(a) at least one diene elastomeric polymer;
(b) at least one organic quaternary ammonium salt having the following general formula (I): 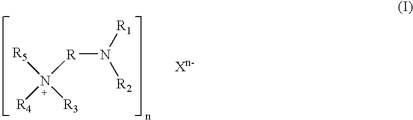
wherein:
   R represents a linear or branched C₁-C₂₂ alkylene group; a linear or branched C₂-C₂₂ alkenylene group; a C₆-C₁₈ arylene group; a C₁-C₂₀ alkylarylene or alkylenearylene group; said groups optionally containing at least one heteroatom selected from oxygen, nitrogen or sulfur;
   R₁ and R₂, which may be identical or different, represent a linear or branched C₁-C₂₂ alkyl group; a linear or branched C₂-C₂₂ alkenyl group; a C₆-C₁₈ aryl group; a C₇-C₂₀ arylalkyl or alkylaryl group; said groups optionally containing at least one heteroatom selected from oxygen, nitrogen or sulfur; or, R₁ and R₂, considered jointly with the nitrogen atom to which they are linked, represent a C₅-C₁₈ heterocyclic ring optionally containing a second heteroatom selected from oxygen, nitrogen or sulfur; or, R₁ and R₅ and/or R₂ and R₃, considered jointly with the nitrogen atoms to which they are linked, represent a C₅-C₁₈ heterocyclic ring;
   R₃, R₄ and R₅, which may be identical or different, represent a linear or branched C₁-C₂₂ alkyl group; a linear or branched C₂-C₂₂ alkenyl group; a C₆-C₁₈ aryl group; a C₇-C₂₀ arylalklyl or alkylaryl group; a group having the following formula: 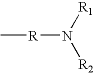
   wherein R, R₁ and R₂, have the same meanings as disclosed above; or two from R₃, R₄ and R₅, considered jointly with the nitrogen atom to which they are linked, represent a C₅-C₁₈ heterocyclic ring optionally containing a second heteroatom selected from oxygen, nitrogen or sulfur;
   Xⁿ⁻ represents an inorganic or organic anion group;
   n represents 1, 2 or 3.

According to one preferred embodiment, the present invention relates to a tyre for vehicle wheels, comprising:
a carcass structure with at least one carcass ply shaped in a substantially toroidal configuration, the opposite lateral edges of which are associated with respective right-hand and left-hand bead wires, each bead wire being enclosed in a respective bead;
a belt structure comprising at least one belt strip applied in a circumferentially external position relative to said carcass structure;
a tread band superimposed circumferentially on said belt structure;
a pair of side walls applied laterally on opposite sides relative to said carcass structure;
   wherein said structural element which includes said elastomeric composition is the tread band.

According to a further aspect, the present invention relates to a tyre tread band including a crosslinkable elastomeric composition comprising:
(a) at least one diene elastomeric polymer;
(b) at least one organic quaternary ammonium salt having the following general formula (I): 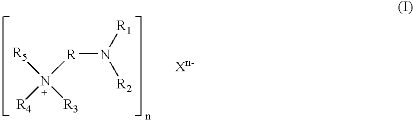
wherein:
   R represents a linear or branched C₁-C₂₂ alkylene group; a linear or branched C₂-C₂₂ alkenylene group; a C₆-C₁ arylene group; a C₇-C₂₀ alkylarylene or alkylenearylene group; said groups optionally containing at least one heteroatom selected from oxygen, nitrogen or sulfur;
   R₁ and R₂, which may be identical or different, represent a linear or branched C₁-C₂₂ alkyl group; a linear or branched C₂-C₂₂ alkenyl group; a C₆-C₁₆ aryl group; a C₇-C₂₀ arylalkyl or alkylaryl group; said groups optionally containing at least one heteroatom selected from oxygen, nitrogen or sulfur; or, R₁ and R₂, considered jointly with the nitrogen atom to which they are linked, represent a C₅-C₁₈ heterocyclic ring optionally containing a second heteroatom selected from oxygen, nitrogen or sulfur; or, R₁ and R₅ and/or R₂ and R₃, considered jointly with the nitrogen atoms to which they are linked, represent a C₅-C₁₈ heterocyclic ring;
   R₃, R₄ and R₅, which may be identical or different, represent a linear or branched C₁-C₂₂ alkyl group; a linear or branched C₂-C₂₂ alkenyl group; a C₆-C₁₈ aryl group; a C₇-C₂₀ arylalklyl or alkylaryl group; a group having the following formula: 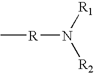
   wherein R, R₁ and R₂, have the same meanings as disclosed above; or two from R₃, R₄ and R₅, considered jointly with the nitrogen atom to which they are linked, represent a C₅-C₁₈ heterocyclic ring optionally containing a second heteroatom selected from oxygen, nitrogen or sulfur;
   Xⁿ⁻ represents an inorganic or organic anion group;
   n represents 1, 2 or 3.

According to a further aspect, the present invention relates to a crosslinkable elastomeric composition comprising:
(a) at least one diene elastomeric polymer;
(b) at least one organic quaternary ammonium salt having the following general formula (I): 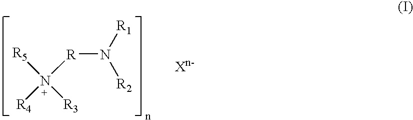
wherein:
   R represents a linear or branched C₁-C₂₂ alkylene group; a linear or branched C₂-C₂₂ alkenylene group; a C₆-C₁₈ arylene group; a C₇-C₂₀ alkylarylene or alkylenearylene group; said groups optionally containing at least one heteroatom selected from oxygen, nitrogen or sulfur;
   R₁ and R₂, which may be identical or different, represent a linear or branched C₃-C₂₂ alkyl group; a linear or branched C₂-C₂₂ alkenyl group; a C₆-C₁₈ aryl group; a C₇-C₂₀ arylalkyl or alkylaryl group; said groups optionally containing at least one heteroatom selected from oxygen, nitrogen or sulfur; or, R₁ and R₂, considered jointly with the nitrogen atom to which they are linked, represent a C₅-C₁₈ heterocyclic ring optionally containing a second heteroatom selected from oxygen, nitrogen or sulfur; or, R₁ and R₅ and/or R₂ and R₃, considered jointly with the nitrogen atoms to which they are linked, represent a C₅-C₁₈ heterocyclic ring;
   R₃, R₄ and R₅, which may be identical or different, represent a linear or branched C₁-C₂₂ alkyl group; a linear or branched C₂-C₂₂ alkenyl group; a C₆-C₁₈ aryl group; a C₇-C₂₀ arylalklyl or alkylaryl group; a group having the following formula: 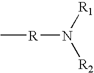
   wherein R, R₁ and R₂, have the same meanings as disclosed above; or two from R₃, R₄ and R₅, considered jointly with the nitrogen atom to which they are linked, represent a C₅-C₁₈ heterocyclic ring optionally containing a second heteroatom selected from oxygen, nitrogen or sulfur;
   Xⁿ⁻ represents an inorganic or organic anion group;
   n represents 1, 2 or 3.

According to a further aspect, the present invention relates to a crosslinked elastomeric manufactured product obtained by crosslinking the abovementioned elastomeric composition.

According to one preferred embodiment, said elastomeric composition is substantially free of additional secondary accelerators [i.e. different from the organic quaternary ammonium salt having general formula (I)], such as, for example, guanidines (e.g. diphenyl guanidine), thiurames, dithiocarbamates, Schiff's bases or other amino accelerators, thiouree.

According to a further preferred embodiment, said elastomeric composition is substantially free of diphenyl guanidine (DPG).

According to a further preferred embodiment, said elastomeric composition may further comprise at least one primary accelerator (c).

For the purposes of the present description and of the claims which follows:
the term “primary accelerator” refers to a compound which increases the vulcanization rate of an elastomeric composition so as to obtain an appreciable degree of crosslinking in an industrially acceptable time; as
the term “secondary accelerator” refers to a compound which appreciably increases the vulcanization rate of an elastomeric composition in the presence of a “primary accelerator” by enhancing the effectiveness of the latter.

According to one preferred embodiment, Xⁿ⁻ may be selected, for example, from: halide ions such as, for example, iodine, bromine, fluorine, or chlorine ions; ipoiodite ion; ipobromite ion; fluorite ion; chlorite ion; iodite ion; bromite ion; fluorine ion; chlorite ion; iodate ion; bromate ion; fluorate ion; chlorate ion; periodate ion; perbromate ion; perfluorate ion; perchlorate ion; nitrate ion; nitrite ion; sulfate ion; sulfite ion; phosphate ion; phosphite ion; hydroxide ion; or an anion represented by the following formulae (II) to (V):
R₆COO⁻ (II)
wherein R₆ represents a linear or branched C₁-C₁₈ alkyl group; a linear or branched C₂-C₁₈ alkenyl group; a C₆-C₁₈ aryl group; a C₇-C₂₀ arylalklyl or alkylaryl group; said groups optionally containing at least one of the following groups: hydroxyl group, carbonyl group, ether group, thioether group, ester group;
⁻OCO—(R₇)ₘ—COO⁻ (III)
wherein m represents 0 or 1; R₇ represents a linear or branched C₁-C₁₈ alkylene group; a linear, branched or cyclic C₂-C₁₈ alkenylene group; a C₆-C₁₈ arylene group; a C₇-C₂₀ arylalklylene or alkylarylene group; said groups optionally containing at least one of the following groups: hydroxyl group, carbonyl group, ether group, thioether group, ester group;,
R₈SOₚ⁻ (IV)
wherein p represent 3 or 4; R₈ represents a linear or branched C₁-C₁₈ alkyl group; a linear or branched C₂-C₁₈ alkenyl group; a C₆-C₁₈ aryl group; a C₇-C₂₀ arylalklyl or alkylaryl group; said groups optionally containing at least one of the following groups: hydroxyl group, carbonyl group, ether group, thioether group, ester group; 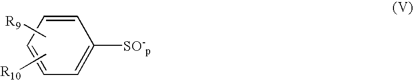
wherein p represents 3 or 4; R₉ and R₁₀, which may be identical or different, represent a hydrogen atom; a linear or branched C₁-C₁₈ alkyl group; a linear or branched C₂-C₁₈ alkenyl group; a C₆-C₁₈ aryl group; a C₇-C₂₀ arylalklyl or alkylaryl group; said groups optionally containing at least one of the following groups: hydroxyl group, carbonyl group, ether group, thioether group, ester group.

Examples of R and R₇ groups are: methylene, ethylene, propylene, butylene, 2,2-dimethyl-1,3-propylene, hexylene, 2-methyl-3-ethyl-1,4-butylene, octylene, vinylene, butenylene, isobutenylene, pentenylene, hexenylene, phenylene, naphtylene, diphenylene, benzenylene, phenylmethylene, phenylethylene, naphtylmethylene, naphtylethylene, methylphenylene, ethylphenylene, methylnaphthylene, ethylnaphthylene.

Examples of R₁, R₂, R₃, R₄, R₅, R₆, R₈, R₉ and R₁₀ groups are: methyl, ethyl, propyl, isopropyl, butyl, isobutyl, pentyl, hexyl, octyl, allyl, methallyl, 2-butenyl, propenyl, hexenyl, octenyl, benzyl, phenyl, naphthyl, methylbenzyl, ethylbenzyl, diphenyl, methylphenyl, ethylphenyl, methylnaphthyl, ethylnaphthyl.

Examples of R₁ and R₂ considered jointly with the nitrogen atom to which they are linked are: morpholine, pyrrolidine, piperidine, N-methyl-piperidine, piperazine, thiomorpholine, thiazolidine, benzothiazolidine, imidazole.

Examples of R₁ and R₅ and/or R₂ and R₃ considered jointly with the nitrogen atom to which they are linked are: piperazine, 1,8-diazabicyclo[2.2.2]octane.

Examples of heterocyclic rings in the case wherein two from R₃, R₄ and R₅, considered jointly with the nitrogen atom to which they are linked, represent a C₅-C₁₈ heterocyclic ring are: pyrrolidinium, piperidinium, piperazinium, imidazolium.

According to one preferred embodiment, said organic quaternary ammonium salt (b) is present in the elastomeric composition in an amount of from 0.1 phr to 10 phr, preferably from 0.5 phr to 5 phr.

For the purposes of the present description and of the claims which follows, the term “phr” means the parts by weight of a given component of the elastomeric composition per 100 parts by weight of the elastomeric polymer.

The quaternary ammonium salt (b) may be added to the elastomeric composition according to the present invention as such or supported on a carrier such as, for example, silica, alumina, carbon black; or dispersed in a polymeric carrier so as to obtain a product in subdivided form (see, for example, the International Patent Application WO 02/083783 in the name of the same Applicant). Alternatively, the quaternary ammonium salt (b) may be used as a solution, e.g. dissolved in a hydroalcoholic solvent such as, for example, water/ethanol, water/isopropanol.

The quaternary ammonium salt (b) may be prepared according to the following processes.

For example, the quaternary ammonium salt (b) may be prepared by a process comprising the reaction of an-amine having the following formula (VI): 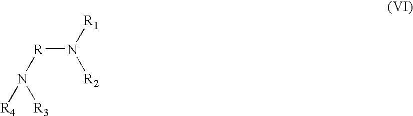
wherein R, R₁, R₂, R₃ and R₄ have the same meanings as disclosed above, with a halogen compound having the following formula (VII):
R₅—Y (VII)
wherein R₅ has the same meanings as disclosed above and Y represents a halogen atom selected from iodine, bromine, fluorine, or chlorine. The reaction may be carried out both at room temperature or at a reflux temperature in the presence of an organic solvent selected, for example, from ethers such as, for example, diethyl ether, dipropyl ether, diisopropyl ether, dibutyl ether, t-butyl methyl ether, diisoamyl ether, tetrahydrofuran, 1,2-dimethoxyethane, 1,2-diethoxyethane, or mixtures thereof; ketones such as, for example, acetone, methyl ethyl ketone, methyl isobutyl ketone, methyl amyl ketone, cyclohexanone; acetonitrile; toluene; or mixture thereof.

Alternatively, the quaternary ammonium salt (b) may be obtained as disclosed, for example, in Bull. Chem. Soc. Jpn. (1986); Vol. 59, pg. 2699-2705.

The quaternary ammonium salt (b) obtained as disclosed above, may be further reacted with a base such as, for example, sodium hydroxide, potassium hydroxide, in stechiometric amount, at room temperature, in the presence of an organic solvent selected, for example, from alcohols such as, for example, methanol, ethanol, n-propanol, acetone, or mixtures therof, obtaining a solid product. The obtained solid product is then treated with an alcoholic solution (for example, ethanol solution) of a compound having the following formula (VIII):
R₆COOH (VIII)
wherein R₆ has the same meanings as disclosed above, in a stechiometric amount, at reflux temperature.

According to one preferred embodiment, the diene elastomeric polymer (a) which may be used in the present invention may be selected from those commonly used in sulphur-crosslinkable elastomeric compositions, that are particularly suitable for producing tyres, that is to say from elastomeric polymers or copolymers with an unsaturated chain having a glass transition temperature (T_{g}) generally below 20° C., preferably in the range of from 0° C. to −90° C. These polymers or copolymers may be of natural origin or may be obtained by solution polymerization, emulsion polymerization or gas-phase polymerization of one or more conjugated diolefins, optionally blended with at least one comonomer selected from monovinylarenes and/or polar comonomers in an amount of not more than 60% by weight.

The conjugated diolefins generally contain from 4 to 12, preferably from 4 to 8 carbon atoms, and may be selected, for example, from the group comprising: 1,3-butadiene, isoprene, 2,3-dimethyl-1,3-butadiene, 1,3-pentadiene, 1,3-hexadiene, 3-butyl-1,3-octadiene, 2-phenyl-1,3-butadiene, or mixtures thereof. 1,3-butadiene and isoprene are particularly preferred.

Monovinylarenes which may optionally be used as comonomers generally contain from 8 to 20, preferably from 8 to 12 carbon atoms, and may be selected, for example, from: styrene; 1-vinylnaphthalene; 2-vinylnaphthalene; various alkyl, cycloalkyl, aryl, alkylaryl or arylalkyl derivatives of styrene such as, for example, α-methylstyrene, 3-methylstyrene, 4-propylstyrene, 4-cyclohexylstyrene, 4-dodecylstyrene, 2-ethyl-4-benzylstyrene, 4-p-tolylstyrene, 4-(4-phenylbutyl)styrene, or mixtures thereof. Styrene is particularly preferred.

Polar comonomers which may optionally be used may be selected, for example, from: vinylpyridine, vinylquinoline, acrylic acid and alkylacrylic acid esters, nitriles, or mixtures thereof, such as, for example, methyl acrylate, ethyl acrylate, methyl methacrylate, ethyl methacrylate, acrylonitrile, or mixtures thereof.

Preferably, the diene elastomeric polymer (a) which may be used in the present invention may be selected, for example, from: cis-1,4-polyisoprene (natural or synthetic, preferably natural rubber), 3,4-polyisoprene, polybutadiene (in particular polybutadiene with a high 1,4-cis content), optionally halogenated isoprene/isobutene copolymers, 1,3-butadiene/acrylonitrile copolymers, styrene/1,3-butadiene copolymers, styrene/isoprene/1,3-butadiene copolymers, styrene/1,3-butadiene/acrylonitrile copolymers, or mixtures thereof.

The elastomeric composition according to the present invention may optionally comprise at least one elastomeric polymer of one or more monoolefins with an olefinic comonomer or derivatives thereof (a′). The monoolefins may be selected from: ethylene and α-olefins generally containing from 3 to 12 carbon atoms, such as, for example, propylene, 1-butene, 1-pentene, 1-hexene, 1-octene, or mixtures thereof. The following are preferred: copolymers between ethylene and an α-olefin, optionally with a diene; isobutene homopolymers or copolymers thereof with small amounts of a diene, which are optionally at least partially halogenated. The diene optionally present generally contains from 4 to 20 carbon atoms and is preferably selected from: 1,3-butadiene, isoprene, 1,4-hexadiene, 1,4-cyclohexadiene, 5-ethylidene-2-norbornene, 5-methylene-2-norbornene, vinylnorbornene, or mixtures thereof. Among these, the following are particularly preferred: ethylene/propylene copolymers (EPR) or ethylene/propylene/diene copolymers (EPDM); polyisobutene; butyl rubbers; halobutyl rubbers, in particular chlorobutyl or bromobutyl rubbers; or mixtures thereof.

A diene elastomeric polymer (a) or an elastomeric polymer (a′) functionalized by reaction with suitable terminating agents or coupling agents may also be used. In particular, the diene elastomeric polymers obtained by anionic polymerization in the presence of an organometallic initiator (in particular an organolithium initiator) may be functionalized by reacting the residual organometallic groups derived from the initiator with suitable terminating agents or coupling agents such as, for example, imines, carbodiimides, alkyltin halides, substituted benzophenones, alkoxysilanes or aryloxysilanes (see, for example, European patent EP 451 604, or patents U.S. Pat. Nos. 4,742,124 and 4,550,142).

The silica based reinforcing filler which may be used in the present invention may be selected from a pyrogenic silica or, preferably, a precipitated silica, with a BET surface area (measured according to ISO standard 5794/1) of from 50 m²/g to 500 m²/g, preferably from 70 m²/g to 200 m²/g.

As disclosed above, the elastomeric composition according to the present invention, may further comprises at least one primary accelerator (c).

According to one preferred embodiment, the primary accelerator (c) may be selected, for example, from:
thiazoles such as, for example, 2-mercaptobenzothiazole (MBT), zinc salt of 2-mercaptobenzothiazole (ZMBT), 2-mercaptobenzothiazole disulphide (MBTS), 2,4-dinitrophenylmercaptobenzothiazole;
sulphenamides such as, for example, N-cyclohexyl-2-benzothiazylsulphenamide (CBS), N-oxydiethylene-2-benzothiazylsulphenamide (OBS), N-t-butyl-2-benzothiazylsulphenamide (TBBS), N,N-dicyclohexyl-2-benzothiazylsulphenamide (DCBS);
xanthogenates such as, for example, zinc isopropylxanthogenate (ZIX), zinc butylxanthogenate (ZBX), sodium isopropylxanthogenate (NaIX), dibutylxanthogenate disulphide (DBX);
   or mixtures thereof. Preferably sulphenamides are used, more preferably N-cyclohexyl-2-benzothiazylsulphenamide (CBS) and N-t-butyl-2-benzothiazylsulphenamide (TBBS), are used

According to one preferred embodiment, said primary accelerator (c) is present in the elastomeric composition in an amount of from 0.1 phr to 10 phr, preferably from 0.5 phr to 5 phr.

At least one reinforcing filler may advantageously be added to the elastomeric composition according to the present invention, in an amount generally of between 0.1 phr and 120 phr, preferably between 20 phr and 90 phr. The reinforcing filler may be chosen from those commonly used for crosslinked manufactured products, in particular for tyres, such as, for example, carbon black, silica, alumina, aluminosilicates, calcium carbonate, kaolin, or mixtures thereof.

The types of carbon black which may be used according to the present invention may be chosen from those conventionally used in the production of tyres, generally having a surface area of not less than 20 m²/g (determined by CTAB absorption as described in ISO standard 6810).

The silica which may be used according to the present invention may generally be a pyrogenic silica or, preferably, a precipitated silica, with a BET surface area (measured according to ISO standard 5794/1) of between 50 M²/g and 500 m²/g, preferably between 70 m²/g and 200 m²/g.

When a reinforcing filler comprising silica is present, the elastomeric composition may advantageously incorporate a coupling agent capable of acting with the silica and of linking it to the elastomeric base during the vulcanization.

Coupling agents that are preferably used are those based on silane which may be identified, for example, by the following structural formula (IX):
(R)₃Si—CₙH₂ₙ—X (IX)
in which the groups R, which may be identical or different, are chosen from: alkyl, alkoxy or aryloxy groups or from halogen atoms, on condition that at least one of the groups R is an alkoxy or aryloxy group; n is an integer between 1 and 6 inclusive; X is a group chosen from: nitroso, mercapto, amino, epoxide, vinyl, imide, chloro, —(S)ₘCₙH₂ₙ—Si—(R)₃ in which m and n are integers between 1 and 6 inclusive and the groups R are defined as above.

Among the coupling agents that are particularly preferred are bis(3-triethoxysilylpropyl) tetrasulphide and bis(3-triethoxysilylpropyl) disulphide. Said coupling agents may be used as such or as a suitable mixture with an inert filler (for example carbon black) so as to facilitate their incorporation into the elastomeric composition.

The elastomeric composition according to the present invention may be vulcanized according to known techniques, in particular with sulphur-based vulcanizing systems commonly used for diene elastomeric polymers. To this end, in the elastomeric composition, after one or two steps of thermomechanical processing, a sulphur-based vulcanizing agent is incorporated together with vulcanization accelerators. In this second or third processing step, the temperature is generally kept below 120° C. and preferably below 100° C., so as to avoid any unwanted pre-crosslinking phenomena. The organic quaternary ammonium salt (b) may be added to the elastomeric composition according to the present invention during any one of the above reported steps.

The vulcanizing agent most advantageously used is sulphur, or molecules containing sulphur (sulphur donors), with accelerators and activators known to those skilled in the art.

Activators that are particularly effective are zinc compounds, and in particular ZnO, ZnCO₃, zinc salts of saturated or unsaturated fatty acids containing from 8 to 18 carbon atoms, such as, for example, zinc stearate, which are preferably formed in situ in the elastomeric composition from ZnO and fatty acid such as, for example, stearic acid, and also BiO, PbO, Pb₃O₄, PbO₂, or mixtures thereof. As already disclosed above, in the case of an organic quaternary ammonium salt (b) wherein the anion group is a carboxylate anion, the addition of stearic acid may be avoided.

The elastomeric composition according to the present invention may further comprise other commonly used additives selected on the basis of the specific application for which the composition is intended. For example, the following may be added to said composition: antioxidants, anti-ageing agents, plasticizers, adhesives, anti-ozone agents, modifying resins, fibres (for example Kevlar® pulp), or mixtures thereof.

In particular, for the purpose of further improving the processability, a plasticizer generally selected from mineral oils, vegetable oils, synthetic oils, or mixtures thereof, such as, for example, aromatic oil, naphthenic oil, phthalates, soybean oil, or mixtures thereof, may be added to the elastomeric composition according to the present invention. The amount of plasticizer generally ranges from 2 phr to 100 phr, preferably from 5 phr to 50 phr.

The elastomeric composition according to the present invention may be prepared by mixing together the diene elastomeric polymers with the reinforcing filler and with the other additives optionally present according to techniques known in the art. The mixing may be carried out, for example, using an open mixer of open-mill type, or an internal mixer of the type with tangential rotors (Banbury) or with interlocking rotors (Intermix), or in continuous mixers of Ko-Kneader type (Buss) or of co-rotating or counter-rotating twin-screw type.

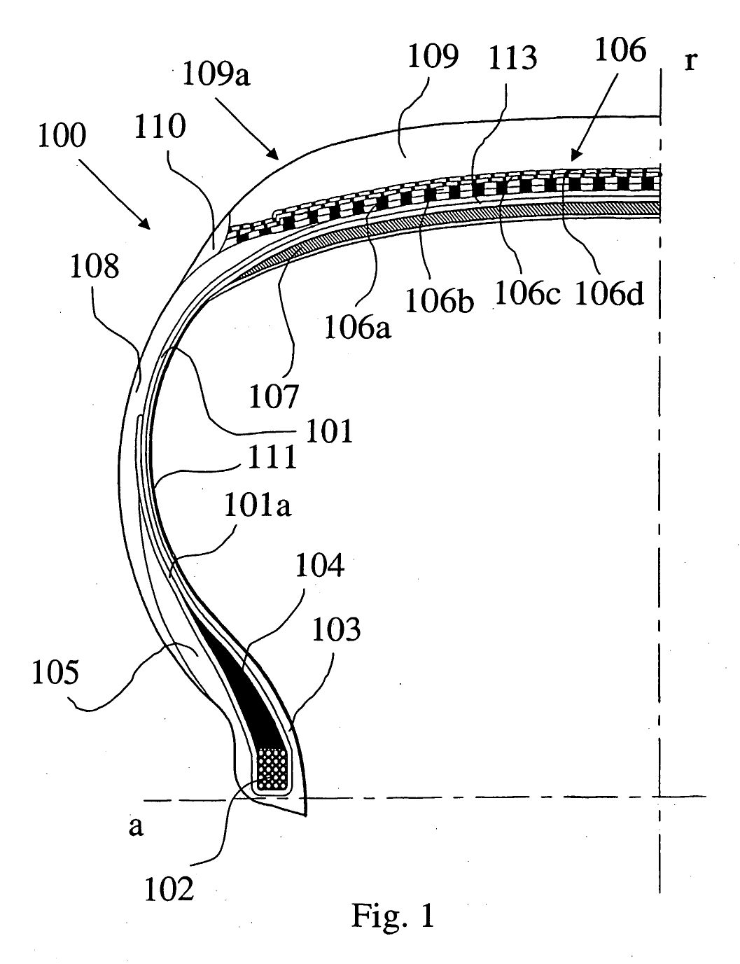

The present invention will now be illustrated in further detail by means of a number of illustrative embodiments, with reference to the attached FIG. 1, which is a view in cross section of a portion of a tyre made according to the invention.

“a” indicates an axial direction and “r” indicates a radial direction. For simplicity, FIG. 1 shows only a portion of the tyre, the remaining portion not represented being identical and symmetrically arranged with respect to the radial direction “r”.

The tyre (100) comprises at least one carcass ply (101), the opposite lateral edges of which are associated with respective bead wires (102). The association between the carcass ply (101) and the bead wires (102) is achieved here by folding back the opposite lateral edges of the carcass ply (101) around the bead wires (102) so as to form the so-called carcass back-folds (101a) as shown in FIG. 1.

Alternatively, the conventional bead wires (102) can be replaced with a pair of circumferentially inextensible annular inserts formed from elongate components arranged in concentric coils (not represented in FIG. 1) (see, for example, European patent applications EP 928,680 and EP 928,702). In this case, the carcass ply (101) is not back-folded around said annular inserts, the coupling being provided by a second carcass ply (not represented in FIG. 1) applied externally over the first.

The carcass ply (101) generally consists of a plurality of reinforcing cords arranged parallel to each other and at least partially coated with a layer of elastomeric compound. These reinforcing cords are usually made of textile fibres, for example rayon, nylon or polyethylene terephthalate, or of steel wires stranded together, coated with a metal alloy (for example copper/zinc, zinc/manganese, zinc/molybdenum/cobalt alloys and the like).

The carcass ply (101) is usually of radial type, i.e. it incorporates reinforcing cords arranged in a substantially perpendicular direction relative to a circumferential direction. Each bead wire (102) is enclosed in a bead (103), defined along an inner circumferential edge of the tyre (100), with which the tyre engages on a rim (not represented in FIG. 1) forming part of a vehicle wheel. The space defined by each carcass back-fold (101a) contains a bead filler (104) wherein the bead wires (102) are embedded. An antiabrasive strip (105) is usually placed in an axially external position relative to the carcass back-fold (101a).

A belt structure (106) is applied along the circumference of the carcass ply (101). In the particular embodiment in FIG. 1, the belt structure (106) comprises two belt strips (106a, 106b) which incorporate a plurality of reinforcing cords, typically metal cords, which are parallel to each other in each strip and intersecting with respect to the adjacent strip, oriented so as to form a predetermined angle relative to a circumferential direction. On the radially outermost belt strip (106b) may optionally be applied at least one zero-degree reinforcing layer (106c), commonly known as a “0° belt”, which generally incorporates a plurality of reinforcing cords, typically textile cords, arranged at an angle of a few degrees relative to a circumferential direction, and coated and welded together by means of an elastomeric material.

A side wall (108) is also applied externally onto the carcass ply (101) this side wall extending, in an axially external position, from the bead (103) to the end of the belt structure (106).

A tread band (109), whose lateral edges are connected to the side walls (108), is applied circumferentially in a position radially external to the belt structure (106). Externally, the tread band (109) has a rolling surface (109a) designed to come into contact with the ground. Circumferential grooves which are connected by transverse notches (not represented in FIG. 1) so as to define a plurality of blocks of various shapes and sizes distributed over the rolling surface (109a) are generally made in this surface (109a), which is represented for simplicity in FIG. 1 as being smooth.

A strip made of elastomeric material (110), commonly known as a “mini-side wall”, may optionally be present in the connecting zone between the side walls (108) and the tread band (109), this mini-side wall generally being obtained by co-extrusion with the tread band and allowing an improvement in the mechanical interaction between the tread band (109) and the side walls (108). Alternatively, the end portion of the side wall (108) directly covers the lateral edge of the tread band (109). A underlayer which forms, with the tread band (109), a structure commonly known as a “cap and base” (not represented in FIG. 1) may optionally be placed between the belt structure (106) and the tread band (109).

A layer of elastomeric material (111) which serves as an “attachment sheet”, i.e. a sheet capable of providing the connection between the tread band (109) and the belt structure (106), may be placed between the tread band (109) and the belt structure (106).

In the case of tubeless tyres, a rubber layer (112) generally known as a “liner”, which provides the necessary impermeability to the inflation air of the tyre, may also be provided in a radially internal position relative to the carcass ply (101).

The process for producing the tyre according to the present invention may be carried out according to techniques and using apparatus that are known in the art, as described, for example, in patents EP 199 064, U.S. Pat. Nos. 4,872,822, 4,768,937, said process including at least one step of manufacturing the green tyre and at least one step of vulcanizing this tyre.

More particularly, the process for producing the tyre comprises the steps of preparing, beforehand and separately from each other, a series of semi-finished products corresponding to the various parts of the tyre (carcass plies, belt structure, bead wires, fillers, side walls and tread band) which are then combined together using a suitable manufacturing machine. Next, the subsequent vulcanization step welds the abovementioned semi-finished products together to give a monolithic block, i.e. the finished tyre.

Naturally, the step of preparing the abovementioned semi-finished products will be preceded by a step of preparing and moulding the various blends, of which said semi-finished products are made, according to conventional techniques.

The green tyre thus obtained is then passed to the subsequent steps of moulding and vulcanization. To this end, a vulcanization mould is used which is designed to receive the tyre being processed inside a moulding cavity having walls which are countermoulded to define the outer surface of the tyre when the vulcanization is complete.

Alternative processes for producing a tyre or parts of a tyre without using semi-finished products are disclosed, for example, in the abovementioned patent applications EP 928,680 and EP 928,702.

The green tyre may be moulded by introducing a pressurized fluid into the space defined by the inner surface of the tyre, so as to press the outer surface of the green tyre against the walls of the moulding cavity. In one of the moulding methods widely practised, a vulcanization chamber made of elastomeric material, filled with steam and/or another fluid under pressure, is inflated inside the tyre closed inside the moulding cavity. In this way, the green tyre is pushed against the inner walls of the moulding cavity, thus obtaining the desired moulding. Alternatively, the moulding may be carried out without an inflatable vulcanization chamber, by providing inside the tyre a toroidal metal support shaped according to the configuration of the inner surface of the tyre to be obtained as decribed, for example, in patent EP 242,840. The difference in coefficient of thermal expansion between the toroidal metal support and the crude elastomeric material is exploited to achieve an adequate moulding pressure.

At this point, the step of vulcanizing the crude elastomeric material present in the tyre is carried out. To this end, the outer wall of the vulcanization mould is placed in contact with a heating fluid (generally steam) such that the outer wall reaches a maximum temperature generally of between 100° C. and 230° C. Simultaneously, the inner surface of the tyre is heated to the vulcanization temperature using the same pressurized fluid used to press the tyre against the walls of the moulding cavity, heated to a maximum temperature of between 100° C. and 250° C. The time required to obtain a satisfactory degree of vulcanization throughout the mass of the elastomeric material may vary in general between 3 min and 90 min and depends mainly on the dimensions of the tyre. When the vulcanization is complete, the tyre is removed from the vulcanization mould.

Although the present invention has been illustrated specifically in relation to a tyre, other crosslinked elastomeric manufactured products that may be produced according to the invention may be, for example, conveyor belts, driving belts or flexible tubes.

The present invention will be further illustrated below by means of a number of preparation examples, which are given for purely indicative purposes and without any limitation of this invention.

### EXAMPLE 1

### Preparation of the Organic Quaternary Ammonium Salt

In a 1 1 reaction vessel were charged 0.15 mol of 1-bromo-decane, 0.18 mol of 1,4-diaza-biciclo[2.2.2]octane (DABCO) and 400 ml of t-butyl methyl ether. The reaction mixture was then heated at reflux temperature for 21 hours.

The t-butyl methyl ether was then removed from the reaction product under reduced pressure obtaining a solid product.

The solid product so obtained was then filtered, washed with t-butyl methyl ether and dried under reduced pressure to obtain 41.87 g (yield 83.7%) of the desired product.

### EXAMPLE 2

### Preparation of the Organic Quaternary Ammonium Salt

In a 1 1 reaction vessel were charged 0.15 mol of 1-chloro-eptane, 0.18 mol of 1,4-diazabiciclo[2.2.2]octane (DABCO) and 400 ml of acetone. The reaction mixture was then heated at reflux temperature for 24 hours.

The acetone was then removed from the reaction product under reduced pressure obtaining an oil.

The obtained oil was washed with diethyl ether and then dried under reduced pressure to obtain a 29.2 g (yield 79%) of the desired product.

### EXAMPLE 3

### Preparation of the Organic Quaternary Ammonium Salt

In a 250 ml reaction vessel were charged 0.084 mol of the quaternary ammonium salt obtained as disclosed in Example 1, 0.084 mol of potassium hydroxide and 90 ml of ethanol. The reaction mixture was then stirred, at room temperature, for 30 minutes. Then, the solution was cooled at 0° C. and was kept at this temperature for 30 minutes obtainig a solid product.

The obtained solid product was then filtered, washed with 10 ml of cold ethanol and then treated with a solution of 0.084 ml of stearic acid in 124 ml of ethanol.

The obtained solution was then heated at reflux temperature for 1 hour. A white solid product was precipitated at room temperature and removed by filtration. The filtered solution was concentrated at reduced pressure, at 50° C., to obtain a solid product which was then washed with tetrahydrofuran and dried under reduced pressure to obtain 18.56 g (78%) of the desired product.

### EXAMPLE 4-8

### Preparation of the Elastomeric Compositions

The elastomeric compositions given in Table 1 were prepared as follows (the amounts of the various components are given in phr).

All the ingredients, except zinc oxide, sulphur, antioxidant, ammonium salt, and accelerator, were mixed together in an internal mixer (model Pomini PL 1.6) for about 5 min (1^{st} Step). When a temperature of 145±5° C. was reached, the elastomeric composition was discharged. Then zinc oxide and antioxidant were added and mixing was carried out in an internal mixer (model Pomini PL 1.6) for about 5 min (₂nd Step). When a temperature of 125±5° C. was reached, the elastomeric composition was discharged. Then sulphur, ammonium salt and accelerator were added and mixing was carried out in an open roll mixer (3^{rd} Step).

TABLE 1

| EXAMPLE | | | | | |
|---|---|---|---|---|---|
| 4⁽*⁾ | 5⁽*⁾ | 6⁽*⁾ | 7 | 8 | 9 |

1^{st} Step

| | | | | | | |
|---|---|---|---|---|---|---|
| S-SBR | 90 | 90 | 90 | 90 | 90 | 90 |
| BR | 35 | 35 | 35 | 35 | 35 | 35 |
| Silica | 70 | 70 | 70 | 70 | 70 | 70 |
| TESPT | 5.6 | 5.6 | 5.6 | 5.6 | 5.6 | 5.6 |
| Stearic acid | 2 | 2 | 2 | 2 | 2 | — |
| Aromatic oil | 8 | 8 | 8 | 8 | 8 | 8 |
| Microcrystalline | 1 | 1 | 1 | 1 | 1 | 1 |
| wax | | | | | | |

2^{nd} Step

| | | | | | | |
|---|---|---|---|---|---|---|
| Zinc oxide | 2.5 | 2.5 | 2.5 | 2.5 | 2.5 | 2.5 |
| Antioxidant | 2 | 2 | 2 | 2 | 2 | 2 |

3^{rd} Step

| | | | | | | |
|---|---|---|---|---|---|---|
| Bardac ® LF-80 | — | — | 2.8 | — | — | — |
| Ammonium salt | — | — | — | 2.8 | — | — |
| (1) | | | | | | |
| Ammonium salt | — | — | — | — | 2.8 | — |
| (2) | | | | | | |
| Ammonium salt | | | | | | 3.3 |
| (3) | | | | | | |
| DPG | 1.9 | — | — | — | — | — |
| CBS | 2 | 2 | 2 | 2 | 2 | 2 |
| Sulphur | 1.2 | 1.2 | 1.2 | 1.2 | 1.2 | 1.2 |

⁽*⁾comparative.

S-SBR: styrene/butadiene copolymer, obtained by solution polymerization, containing 25% by weight of styrene, mixed with 37.5 phr of oil (Buna® 5025—Bayer);
BR: cis-1,4-polybutadiene (Europrene® BR 40—EniChem Elastomeri);
Silica: precipitated silica (Zeosil® 1165 MP—Rhone-Poulenc);
TESPT: bis(3-triethoxysilylpropyl)tetrasulfide (X50S comprising 50% of carbon black and 50% of silane—Degussa-Hüls—the reported amount relates to the silane amount);
Bardac® LF-80: dioctyl dimethyl ammonium chloride, 80% active form (Lonza);
Ammonium salt (1): ammonium salt of Example 1;
Ammonium salt (2): ammonium salt of Example 2;
Ammonium salt (3): ammonium salt of Example 3;
Antioxidant: N-1,3-dimethylbutyl-N′-phenyl-p-phenylenediamine; DPG (secondary accelerator): N-N′-diphenylguanidine; CBS (primary accelerator): N-cyclohexyl-2-benzotiazyl-sulfenamide (Vulkacit® CZ—Bayer);

The Mooney viscosity ML(1+4) at 100° C. was measured, according to ISO standard 289/1, on the non-crosslinked compositions obtained as described above. The results obtained are given in Table 2.

Said elastomeric compositions were also submitted to a MDR rheometric analysis using a MDR rheometer from Monsanto, the tests being run at 170° C. for 20 minutes, with an oscillation frequency of 1.66 Hz (100 oscillations per minute) and an oscillation amplitude of ±0.50. The static mechanical properties according to ISO standard 37 as well as hardness in IRHD degrees at 23° C. according to ISO standard 48 were measured on samples of said elastomeric compositions cross-linked at 170° C. for 10 minutes. The results obtained are given in Table 2.

Also given in Table 2 are the dynamic mechanical properties measured using an Instron dynamic device in the traction-compression mode according to the following methods. A test piece of the crosslinked material having a cylindrical form (length=25 mm; diameter=14 mm) compression-preloaded up to 25% longitudinal deformation with respect to the initial length and kept at the prefixed temperature (23° C. and 70° C.) for the whole duration of the test, was submitted to a dynamic sinusoidal strain with an amplitude ±3.33% with respect to the length under pre-load, with a frequency of 100 Hz. The dynamic mechanical properties are expressed in terms of dynamic elastic modulus (E′) and tandelta (loss factor) values. As is known, the tandelta value is calculated as a ratio between the viscous modulus (E″) and the elastic modulus (E′), both of them being determined with the above dynamic measurements.

Lastly the DIN abrasion values were measured according to DIN standard 53516, also reported in Table 2, expressed as the amount of compound removed.

TABLE 2

| | EXAMPLE | | | | | |
|---|---|---|---|---|---|---|
| | 4⁽*⁾ | 5⁽*⁾ | 6⁽*⁾ | 7 | 8 | 9 |
| Mooney | 74.20 | 87.20 | 65.40 | 76.70 | 76.60 | 77.9 |
| viscosity | | | | | | |
| ML (1 + 4) | | | | | | |

STATIC MECHANICAL PROPERTIES

| | | | | | | |
|---|---|---|---|---|---|---|
| Stress at | 14.11 | 16.24 | 13.41 | 14.97 | 13.91 | 11.70 |
| break | | | | | | |
| (MPa) | | | | | | |
| Elongation | 426.00 | 612.10 | 406.90 | 440.50 | 374.30 | 374.0 |
| at break | | | | | | |
| (MPa) | | | | | | |

DYNAMIC MECHANICAL PROPERTIES

| | | | | | | |
|---|---|---|---|---|---|---|
| E′ (23° C.) | 8.277 | 7.735 | 6.974 | 7.791 | 7.784 | 7.080 |
| E′ (70° C.) | 5.988 | 5.446 | 5.510 | 5.940 | 5.953 | 5.241 |
| Tandelta | 0.268 | 0.282 | 0.224 | 0.233 | 0.226 | 0.236 |
| (23° C.) | | | | | | |
| Tandelta | 0.140 | 0.165 | 0.110 | 0.122 | 0.120 | 0.134 |
| (70° C.) | | | | | | |

RHEOMETRIC PROPERTIES

| | | | | | | |
|---|---|---|---|---|---|---|
| ML (dN M) | 3.08 | 4.03 | 2.20 | 2.75 | 3.09 | 3.14 |
| MH (dN m) | 20.51 | 22.07 | 17.89 | 19.05 | 18.99 | 21.19 |
| t30 (min) | 2.13 | 2.40 | 2.16 | 1.52 | 1.06 | 1.17 |
| t90 (min) | 4.12 | 13.18 | 5.63 | 5.64 | 3.69 | 5.19 |
| IRHD | 69.7 | 66.9 | 65.3 | 67.1 | 68.8 | 70.0 |
| Hardness | | | | | | |
| (23° C.) | | | | | | |
| IRHD | 64.7 | 60.8 | 62.1 | 62.7 | 63.6 | 64.2 |
| Hardness | | | | | | |
| (100° C.) | | | | | | |
| DIN | 86.3 | 74.3 | 100.7 | 85.1 | 84.4 | 76.0 |
| Abrasion | | | | | | |

⁽*⁾comparative.

The results given in Table 2 show that the crosslinkable composition comprising the organic quaternary ammonium salt according to the present invention (Examples 7, 8 and 9) has high vulcanization rate without impairing mechanical properties (both static and dynamic). Moreover, with respect to the elastomeric composition including different organic quaternary ammonium salt (Example. 6), an improved abrasion resistance is achieved.

1-50. (canceled)

51. A tyre for a vehicle wheel, comprising at least one structural element comprising an elastomeric composition, the elastomeric composition comprising:
at least one diene elastomeric polymer; and
at least one organic quaternary ammonium salt having a following general formula (I): 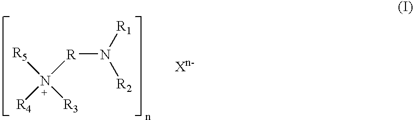
wherein R represents a linear or branched C₁-C₂₂ alkylene group; a linear or branched C₂-C₂₂ alkenylene group; a C₆-C₁₈ arylene group; and/or a C₇-C₂₀ alkylarylene or alkylenearylene group; the group or groups optionally containing at least one heteroatom selected from oxygen, nitrogen, and/or sulfur,
wherein R₁ and R₂, which may be identical or different, represent a linear or branched C₁-C₂₂ alkyl group; a linear or branched C₂-C₂₂ alkenyl group; a C₆-C₁₈ aryl group; and/or a C₇-C₂₀ arylalkyl or alkylaryl group; the group or groups optionally containing at least one heteroatom selected from oxygen, nitrogen, and/or sulfur; or, R₁ and R₂, considered jointly with the nitrogen atom to which they are linked, represent a C₅-C₁₈ heterocyclic ring optionally containing a second heteroatom selected from oxygen, nitrogen, and/or sulfur; or, R₁ and R₅ and/or R₂ and R₃, considered jointly with the nitrogen atoms to which they are linked, represent a C₅-C₁₈ heterocyclic ring,
wherein R₃, R₄, and R₅, which may be identical or different, represent a linear or branched C₁-C₂₂ alkyl group; a linear or branched C₂-C₂₂ alkenyl group; a C₆-C₁₈ aryl group; a C₇-C₂₀ arylalkyl or alkylaryl group; and/or a group having a following formula: 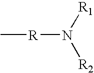
wherein R, R₁, and R₂, have the same meanings as disclosed above; or two from R₃, R₄, and R₅, considered jointly with the nitrogen atom to which they are linked, represent a C₅-C₁₈ heterocyclic ring optionally containing a second heteroatom selected from oxygen, nitrogen, and/or sulfur,
wherein Xⁿ⁻ represents an inorganic or organic anion group, and
wherein n represents 1, 2, or 3.

52. The tyre of claim 51, comprising:
a carcass structure;
a belt structure;
a tread band; and
a pair of sidewalls;
wherein the carcass structure comprises at least one carcass ply,
wherein the at least one carcass ply is shaped in a substantially toroidal configuration,
wherein opposite lateral edges of the carcass structure are associated with respective bead wires,
wherein each bead wire is enclosed in a respective bead,
wherein the belt structure comprises at least one belt strip applied in a circumferentially external position relative to the carcass structure;
wherein the tread band is superimposed circumferentially on the belt structure,
wherein the sidewalls are applied laterally on opposite sides relative to the carcass structure, and
wherein the at least one structural element comprising the elastomeric composition is the tread band.

53. The tyre of claim 51, wherein the elastomeric composition is substantially free of additional secondary accelerators.

54. The tyre of claim 51, wherein the elastomeric composition is substantially free of diphenyl guanidine (DPG).

55. The tyre of claim 51, wherein Xⁿ⁻ is selected from: halide ions such as iodine, bromine, fluorine, or chlorine ions; ipoiodite ion; ipobromite ion; fluorite ion; chlorite ion; iodite ion; bromite ion; fluorine ion; chlorite ion; iodate ion; bromate ion; fluorate ion; chlorate ion; periodate ion; perbromate ion; perfluorate ion; perchlorate ion; nitrate ion; nitrite ion; sulfate ion; sulfite ion; phosphate ion; phosphite ion; hydroxide ion; or an anion group represented by a following formulae (II) to (V):
RCOO⁻ (II)
wherein R₆ represents a linear or branched C₁-C₁₈ alkyl group; a linear or branched C₂-C₁₈ alkenyl group; a C₆-C₁₈ aryl group; or a C₇-C₂₀ arylalkyl or alkylaryl group; the group or groups optionally containing at least one of the following: a hydroxyl group, a carbonyl group, an ether group, a thioether group, and/or an ester group;
⁻OCO—(R₇)ₘ—COO⁻ (III)
wherein m represents 0 or 1; R₇ represents a linear or branched C₁-C₁₈ alkylene group; a linear, branched or cyclic C₂-C₁₈ alkenylene group; a C₆-C₁₈ arylene group; or a C₇-C₂₀ arylalkylene or alkylarylene group; the group or groups optionally containing at least one of the following: a hydroxyl group, a carbonyl group, an ether group, a thioether group, and/or an ester group;
R₈SOₚ⁻ (IV)
wherein p represent 3 or 4; R₈ represents a linear or branched C₁-C₁₈ alkyl group; a linear or branched C₂-C₁₈ alkenyl group; a C₆-C₁₈ aryl group; or a C₇-C₂₀ arylalkyl or alkylaryl group; the group or groups optionally containing at least one of the following: a hydroxyl group, a carbonyl group, an ether group, a thioether group, and/or an ester group; 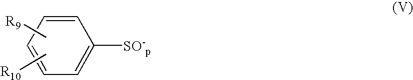
wherein p represents 3 or 4; R₉ and R₁₀, which may be identical or different, represent a hydrogen atom; a linear or branched C₁-C₁₈ alkyl group; a linear or branched C₂-C₁₈ alkenyl group; a C₆-C₁₈ aryl group; and/or a C₇-C₂₀ arylalkyl or alkylaryl group; the group or groups optionally containing at least one of the following: a hydroxyl group, a carbonyl group, an ether group, a thioether group, and/or an ester group.

56. The tyre of claim 55, wherein R and R₇ represent one or more of: methylene, ethylene, propylene, butylene, 2,2-dimethyl-1,3-propylene, hexylene, 2-methyl-3-ethyl-1,4-butylene, octylene, vinylene, butenylene, isobutenylene, pentenylene, hexenylene, phenylene, naphtylene, diphenylene, benzenylene, phenylmethylene, phenylethylene, naphtylmethylene, naphtylethylene, methylphenylene, ethylphenylene, methylnaphthylene, and ethylnaphthylene.

57. The tyre of claim 55, wherein R₁, R₂, R₃, R₄, R₅, R₆, R₈, R₉, and R₁₀ represent one or more of: methyl, ethyl, propyl, isopropyl, butyl, isobutyl, pentyl, hexyl, octyl, allyl, methallyl, 2-butenyl, propenyl, hexenyl, octenyl, benzyl, phenyl, naphthyl, methylbenzyl, ethylbenzyl, diphenyl, methylphenyl, ethylphenyl, methylnaphthyl, and ethylnaphthyl.

58. The tyre of claim 51, wherein R₁ and R₂, considered jointly with the nitrogen atom or atoms to which they are linked, represent one or more of: morpholine, pyrrolidine, piperidine, N-methyl-piperidine, piperazine, thiomorpholine, thiazolidine, benzothiazolidine, and imidazole.

59. The tyre of claim 51, wherein R₁ and R₅ and/or R₂ and R₃, considered jointly with the nitrogen atoms to which they are linked, represent one or more of: piperazine and 1,8-diazabicyclo[2.2.2]octane.

60. The tyre of claim 51, wherein in a case wherein two from R₃, R₄, and R₅, considered jointly with the nitrogen atom or atoms to which they are linked, represent a C₅-C₁₈ heterocyclic ring, the heterocyclic ring or rings represent one or more of: pyrrolidinium, piperidinium, piperazinium, and imidazolium.

61. The tyre of claim 51, wherein the at least one organic quaternary ammonium salt is present in the elastomeric composition in an amount from 0.1 phr to 10 phr.

62. The tyre of claim 51, wherein the at least one organic quaternary ammonium salt is present in the elastomeric composition in an amount from 0.5 phr to 5 phr.

63. The tyre of claim 51, wherein the at least one diene elastomeric polymer has a glass transition temperature (T_{g}) below 20° C.

64. The tyre of claim 63, wherein the at least one diene elastomeric polymer comprises one or more of: cis-1,4-polyisoprene; 3,4-polyisoprene; polybutadiene; optionally halogenated isoprene/isobutene copolymers; 1,3-butadiene/acrylonitrile copolymers; styrene/1,3-butadiene copolymers; styrene/isoprene/1,3-butadiene copolymers; and styrene/1,3-butadiene/acrylonitrile copolymers.

65. The tyre of claim 51, wherein the elastomeric composition further comprises at least one elastomeric polymer of one or more monoolefins with an olefinic comonomer or derivatives thereof.

66. The tyre of claim 65, wherein the at least one elastomeric polymer comprises one or more of: ethylene/propylene copolymers (EPR) or ethylene/propylene/diene copolymers (EPDM); polyisobutene; butyl rubbers; and halobutyl rubbers.

67. The tyre of claim 51, wherein the elastomeric composition further comprises at least one primary accelerator.

68. The tyre of claim 67, wherein the at least one primary accelerator is selected from thiazoles, sulphenamides, and/or xanthogenates.

69. The tyre of claim 67, wherein the at least one primary accelerator is selected from sulphenamides.

70. The tyre of claim 67, wherein the at least one primary accelerator is present in the elastomeric composition in an amount from 0.1 phr to 10 phr.

71. The tyre of claim 67, wherein the at least one primary accelerator is present in the elastomeric composition in an amount from 0.5 phr to 5 phr.

72. The tyre of claim 51, wherein the elastomeric composition further comprises at least one reinforcing filler in an amount between 0.1 phr and 120 phr.

73. The tyre of claim 72, wherein the at least one reinforcing filler comprises carbon black.

74. The tyre of claim 72, wherein the at least one reinforcing filler comprises silica.

75. The tyre of claim 74, wherein the elastomeric composition further comprises a silica coupling agent.

76. A tread band for a tyre, the tread band comprising a crosslinkable elastomeric composition, the elastomeric composition comprising:
at least one diene elastomeric polymer; and
at least one organic quaternary ammonium salt having a following general formula (I): 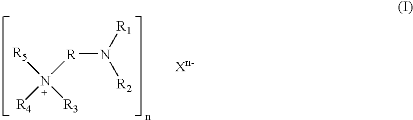
wherein R represents a linear or branched C₁-C₂₂ alkylene group; a linear or branched C₂-C₂₂ alkenylene group; a C₆-C₁₈ arylene group; and/or a C₇-C₂₀ alkylarylene or alkylenearylene group; the group or groups optionally containing at least one heteroatom selected from oxygen, nitrogen, and/or sulfur,
wherein R₁ and R₂, which may be identical or different, represent a linear or branched C₁-C₂₂ alkyl group; a linear or branched C₂-C₂₂ alkenyl group; a C₆-C₁₈ aryl group; and/or a C₇-C₂₀ arylalkyl or alkylaryl group; the group or groups optionally containing at least one heteroatom selected from oxygen, nitrogen, and/or sulfur; or, R₁ and R₂, considered jointly with the nitrogen atom to which they are linked, represent a C₅-C₁₈ heterocyclic ring optionally containing a second heteroatom selected from oxygen, nitrogen, and/or sulfur; or, R₁ and R₅ and/or R₂ and R₃, considered jointly with the nitrogen atoms to which they are linked, represent a C₅-C₁₈ heterocyclic ring,
wherein R₃, R₄, and R₅, which may be identical or different, represent a linear or branched C₁-C₂₂ alkyl group; a linear or branched C₂-C₂₂ alkenyl group; a C₆-C₁₈ aryl group; a C₇-C₂₀ arylalkyl or alkylaryl group; and/or a group having a following formula: 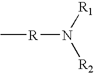
wherein R, R₁, and R₂, have the same meanings as disclosed above; or two from R₃, R₄, and R₅, considered jointly with the nitrogen atom to which they are linked, represent a C₅-C₁₈ heterocyclic ring optionally containing a second heteroatom selected from oxygen, nitrogen, and/or sulfur,
wherein Xⁿ⁻ represents an inorganic or organic anion group, and wherein n represents 1, 2, or 3.

77. The tread band of claim 76, wherein the elastomeric composition is substantially free of additional secondary accelerators.

78. The tread band of claim 76, wherein the elastomeric composition is substantially free of diphenyl guanidine (DPG).

79. The tread band of claim 76, wherein the at least one organic quaternary ammonium salt is present in the elastomeric composition in an amount from 0.1 phr to 10 phr.

80. The tread band of claim 76, wherein the at least one diene elastomeric polymer has a glass transition temperature (T_{g}) below 20° C.

81. The tread band of claim 76, wherein the elastomeric composition further comprises at least one elastomeric polymer of one or more monoolefins with an olefinic comonomer or derivatives thereof.

82. The tread band of claim 76, wherein the elastomeric composition further comprises at least one primary accelerator.

83. The tread band of claim 82, wherein the at least one primary accelerator is selected from thiazoles, sulphenamides, and/or xanthogenates.

84. The tread band of claim 76, wherein the elastomeric composition further comprises at least one reinforcing filler in an amount between 0.1 phr and 120 phr.

85. The tread band of claim 84, wherein the at least one reinforcing filler comprises carbon black.

86. The tread band of claim 84, wherein the at least one reinforcing filler comprises silica.

87. The tread band of claim 86, wherein the elastomeric composition further comprises a silica coupling agent.

88. A crosslinkable elastomeric composition, comprising:
at least one diene elastomeric polymer; and
at least one organic quaternary ammonium salt having a following general formula (I): 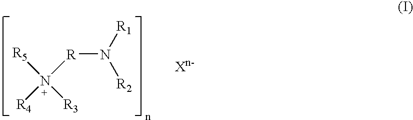
wherein R represents a linear or branched C₁-C₂₂ alkylene group; a linear or branched C₂-C₂₂ alkenylene group; a C₆-C₁₈ arylene group; and/or a C₇-C₂₀ alkylarylene or alkylenearylene group; the group or groups optionally containing at least one heteroatom selected from oxygen, nitrogen, and/or sulfur,
wherein R₁ and R₂, which may be identical or different, represent a linear or branched C₁-C₂₂ alkyl group; a linear or branched C₂-C₂₂ alkenyl group; a C₆-C₁₈ aryl group; and/or a C₇-C₂₀ arylalkyl or alkylaryl group; the group or groups optionally containing at least one heteroatom selected from oxygen, nitrogen, and/or sulfur; or, R₁ and R₂, considered jointly with the nitrogen atom to which they are linked, represent a C₅-C₁₈ heterocyclic ring optionally containing a second heteroatom selected from oxygen, nitrogen, and/or sulfur; or, R₁ and R₅ and/or R₂ and R₃, considered jointly with the nitrogen atoms to which they are linked, represent a C₅-C₁₈ heterocyclic ring,
wherein R₃, R₄, and R₅, which may be identical or different, represent a linear or branched C₁-C₂₂ alkyl group; a linear or branched C₂-C₂₂ alkenyl group; a C₆-C₁₈ aryl group; a C₇-C₂₀ arylalkyl or alkylaryl group; and/or a group having a following formula: 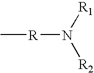
wherein R, R₁, and R₂, have the same meanings as disclosed above; or two from R₃, R₄, and R₅, considered jointly with the nitrogen atom to which they are linked, represent a C₅-C₁₈ heterocyclic ring optionally containing a second heteroatom selected from oxygen, nitrogen, and/or sulfur,
wherein Xⁿ⁻ represents an inorganic or organic anion group, and wherein n represents 1, 2, or 3.

89. The elastomeric composition of claim 88, wherein the elastomeric composition is substantially free of additional secondary accelerators.

90. The elastomeric composition of claim 88, wherein the elastomeric composition is substantially free of diphenyl guanidine (DPG).

91. The elastomeric composition of claim 88, wherein the at least one organic quaternary ammonium salt is present in the elastomeric composition in an amount from 0.1 phr to 10 phr.

92. The elastomeric composition of claim 88, wherein the at least one diene elastomeric polymer has a glass transition temperature (T_{g}) below 20° C.

93. The elastomeric composition of claim 88, further comprising at least one elastomeric polymer of one or more monoolefins with an olefinic comonomer or derivatives thereof.

94. The elastomeric composition of claim 88, further comprising at least one primary accelerator.

95. The elastomeric composition of claim 94, wherein the at least one primary accelerator is selected from thiazoles, sulphenamides, and/or xanthogenates.

96. The elastomeric composition of claim 88, further comprising at least one reinforcing filler in an amount between 0.1 phr and 120 phr.

97. The elastomeric composition of claim 96, wherein the at least one reinforcing filler comprises carbon black.

98. The elastomeric composition of claim 96, wherein the at least one reinforcing filler comprises silica.

99. The elastomeric composition of claim 98, wherein the elastomeric composition further comprises a silica coupling agent.

100. A crosslinked elastomeric manufactured product obtained by crosslinking the elastomeric composition of claim 88.
